(19) United States
(12) Patent Application Publication
(10) Pub. No.: US 2026/0241425 A1
(43) Pub. Date: Aug. 20, 2026

(54) A LOW CARBON EMISSION COUPLED TREATMENT SYSTEM AND METHOD FOR WASTE

(71) Applicant: Guangdong University of Technology, Guangzhou (CN)

(72) Inventors: Xiaozhou Liu, Guangzhou (CN); Rongsen Huang, Guangzhou (CN)

(21) Appl. No.: 19/277,067

(22) Filed: Jul. 22, 2025

Related U.S. Application Data
(63) Continuation of application No. PCT/CN25/83142, filed on Mar. 18, 2025.

(30) Foreign Application Priority Data
Feb. 20, 2025 (CN) 202510190440.6

(51) Int. Cl. B09B 3/30; B01J 21/02; B01J 23/755; B09B 3/10; B09B 3/40; B09B 3/60; B09B 3/70; B09B 3/80; B09B 101/70

(52) U.S. Cl. CPC B09B 3/30; B01J 21/02; B01J 23/755; B09B 3/10; B09B 3/40; B09B 3/60; B09B 3/70; B09B 3/80; B09B 2101/70

(57) ABSTRACT

The present invention relates to a low carbon emission coupled treatment system and method for waste. The method comprises the following steps: kitchen waste is separated into large wet waste and organic residue; the large wet waste is dried and fed into a waste incinerator; the organic residue is fermented to produce biogas, the biogas is burned to heat methanol liquid to generate methanol steam; the methanol steam is mixed with steam and conducted to catalytic hydrogen production to produce a mixed gases rich in hydrogen; sludge is dried, a portion of the dried sludge is fed into a biomass gasifier; the remaining dried sludge is fed into the waste incinerator; the mixed gases rich in hydrogen obtained from catalytic hydrogen production are separated to yield hydrogen and other combustible gases; the biomass gas and the other combustible gases are fed into the waste incinerator for co-combustion.

### CROSS-REFERENCE

This is a U.S. Continuation Application under 35 U.S.C. § 111(a) of International Application No. PCT/CN 2025/083142, filed Mar. 18, 2025, which claims the benefit of priority to Application No. CN 202510190440.6, filed Feb. 20, 2025; both are incorporated by reference for all purposes as if fully set forth herein.

### FIELD

The present invention relates to the technical field of waste treatment, and more particularly to a low carbon emission coupled treatment system and method for waste.

### BACKGROUND

With economic development, the amounts of kitchen waste, domestic sludge, and biomass waste have continuously increased. Incineration can be used to reduce the volume of such waste. However, due to the high moisture content of kitchen waste and domestic sludge, drying treatment is required before incineration.

In existing waste treatment methods, kitchen waste, domestic sludge, and biomass waste are typically incinerated separately. However, since these types of waste generally have low calorific values or are difficult to combust, additional high-calorific-value auxiliary fuels are often required to support combustion. This results in poor treatment efficiency, resource waste, and increased carbon emissions.

### SUMMARY

To overcome the deficiencies of the prior art, in which direct incineration of kitchen waste, domestic sludge, and biomass waste results in poor treatment efficiency, resource waste, and increased carbon emissions, the present invention provides a low carbon emission coupled treatment system and method for waste. This system and method enable the coupled treatment of kitchen waste, domestic sludge, and biomass waste, and utilize waste resources to produce hydrogen.

To address the above technical problems, the present invention adopts the following technical solution:

The present invention provides a low carbon emission coupled treatment method for waste, comprising the following steps:
kitchen waste is sorted to separate large wet waste and organic residue, the large wet waste is dried and then fed into a waste incinerator for combustion, heat of flue gas generated by the waste incinerator is utilized to heat a heat recovery boiler to produce high-temperature and high-pressure steam; wherein the high-temperature and high-pressure steam obtained may be supplied for user applications;
the organic residue is fermented to produce biogas, the biogas is burned to heat methanol liquid to generate methanol steam, the methanol steam is mixed with the high-temperature and high-pressure steam, and the mixture is conducted through catalytic hydrogen production to obtain a mixed gases rich in hydrogen;
sludge is dried, a portion of the dried sludge is fed into a biomass gasifier, to perform coupled gasification fueled with the mixture of dried sludge and biomass waste and generate biomass gas, the remaining dried sludge is fed into the waste incinerator for co-combustion with waste;
the mixed gases rich in hydrogen obtained from catalytic hydrogen production are separated to yield hydrogen and other combustible gases, the hydrogen is delivered externally, the biomass gas and the other combustible gases are fed into the waste incinerator for co-combustion with waste.

In the technical solution of the present invention, the method is used to ferment organic residue separated from kitchen waste to produce biogas, and to burn the biogas to heat methanol liquid and turn it into vapor. By using this method, the methanol vapor is mixed with a portion of the high-temperature and high-pressure steam generated by the heat recovery boiler, and the mixture is subjected to catalytic hydrogen production to obtain hydrogen, thereby achieving reutilization of waste resources. Subsequently, other combustible gases generated during the catalytic hydrogen production are separated from the hydrogen, then the combustible gases are fed back into the waste incinerator for combustion and heat is released. Meanwhile, a mixture of biomass waste and dried sludge is used as fuel for coupled gasification to produce biomass gas. The combustion efficiency of dried kitchen waste, sludge, and domestic waste can be promoted through the co-combustion with the biomass gas, thereby the waste treatment efficiency is improved without requiring additional high-calorific-value auxiliary fuels.

Preferably, the catalytic hydrogen production utilizes porous Ni/Al₂O₃ as a catalyst, and the reaction temperature is 700° C.

Preferably, the mixed gases rich in hydrogen obtained from the catalytic hydrogen production are subjected to separate hydrogen and other combustible gases utilizing an adsorption-desorption bed.

Preferably, the method further comprises the steps of: preheated air, namely high-temperature hot air, is obtained through an air preheater connected to the waste incinerator; a portion of the high-temperature hot air is fed into the waste incinerator to assist combustion; and another portion of the high-temperature hot air, the high-temperature and high-pressure steam, and a portion of the hot flue gas generated by the waste incinerator is fed into the biomass gasifier to perform coupled gasification.

In this technical solution, the method utilizes a mixture composed of high-volatile-content agricultural and forestry waste and dried sludge as feedstock, and employs a gasifying agent composed of high-temperature flue gas, steam, and high-temperature air generated by the waste incinerator. Through high-temperature redox reactions, the method produces biomass gas with high gasification efficiency. The biomass gas promotes waste combustion in the waste incinerator, ensuring stable combustion of waste without the addition of other high-calorific-value auxiliary fuels. This increases the blending ratio of sludge and kitchen waste in domestic waste, reduces slagging in the furnace and the emission of harmful gas, and saves labor and material costs.

Preferably, 10% to 20% of the dried sludge is fed into the biomass gasifier 20, and the remaining sludge is fed into the waste incinerator.

Preferably, both the large wet waste and the sludge are dried by adopting the method of vacuum drying.

The present invention further provides a low carbon emission coupled treatment system for waste, comprising: a kitchen waste sorting device, a biogas fermentation tank, a methanol heating device, a mixer, a catalytic hydrogen production device, an adsorption-desorption bed, a kitchen waste drying device, a sludge drying device, a waste incinerator, a heat recovery boiler, and a biomass gasifier; the kitchen waste sorting device comprises a large wet waste outlet and an organic residue outlet; the biogas fermentation tank comprises an organic residue inlet and a biogas outlet; the methanol heating device comprises a combustion chamber and a heating chamber, the heating chamber including a methanol liquid inlet and a methanol steam outlet; the mixer comprises a steam inlet, a methanol steam inlet, and a mixed raw material outlet; the catalytic hydrogen production device comprises a raw material inlet and a mixed gas outlet; the adsorption-desorption bed comprises a reaction product inlet, a hydrogen outlet, and a mixed combustible gas outlet; the kitchen waste drying device comprises a large wet waste inlet and a dried kitchen waste outlet; the sludge drying device comprises a wet sludge inlet and a dried sludge outlet; the waste incinerator comprises a mixed combustible gas inlet, a dried kitchen waste inlet, a biomass gas inlet, a dried sludge combustion inlet, and a domestic waste inlet; the heat recovery boiler comprises a boiler body, a low-temperature steam outlet, and a high-temperature steam outlet; the biomass gasifier comprises a biomass waste inlet, a biomass gas outlet, and a dried sludge gasification inlet; the large wet waste outlet is connected to the large wet waste inlet; the organic residue outlet is connected to the organic residue inlet; the biogas outlet is connected to the combustion chamber; the dried kitchen waste outlet is connected to the dried kitchen waste inlet; the boiler body is connected to the waste incinerator; the high-temperature steam outlet is connected to the steam inlet; the methanol steam outlet is connected to the methanol steam inlet; the mixed raw material outlet is connected to the raw material inlet; the mixed gas outlet is connected to the reaction product inlet; the mixed combustible gas outlet is connected to the mixed combustible gas inlet; the biomass gas outlet is connected to the biomass gas inlet; the dried sludge outlet is connected to both the dried sludge gasification inlet and the dried sludge combustion inlet.

Further, the low carbon emission coupled treatment system for waste further comprises a low-temperature air preheater and a high-temperature air preheater; the low-temperature air preheater comprises an external air inlet, a low-temperature preheated air outlet, a low-temperature preheating steam inlet, and a low-temperature preheating steam outlet; the high-temperature air preheater comprises a high-temperature preheated air inlet, a high-temperature preheated air outlet, a high-temperature preheating steam inlet, and a high-temperature preheating steam outlet; the waste incinerator comprises a combustion hot air inlet, a first flue gas outlet, and a second flue gas outlet; the biomass gasifier comprises a gasification hot air inlet, a gasification steam inlet, and a gasification flue gas inlet; the low-temperature steam outlet is connected to the low-temperature preheating steam inlet; the high-temperature steam outlet is connected to the high-temperature preheating steam inlet. The high-temperature preheated air outlet is connected to both the combustion hot air inlet and the gasification hot air inlet; the gasification steam inlet is connected to the low-temperature preheating steam outlet; the steam inlet is connected to the high-temperature preheating steam outlet; the gasification flue gas inlet is connected to the first flue gas outlet; the second flue gas outlet is connected to a chimney.

Further, the kitchen waste drying device comprises a first ejector, a first vacuum dryer, a first heating water jacket, and a hot water tank; the first ejector comprises a first high-pressure ejecting inlet, a first low-pressure ejecting inlet, and a first ejecting outlet; the large wet waste inlet and the dried kitchen waste outlet are provided on the first vacuum dryer, which further comprises a first drying outlet; the first heating water jacket comprises a first ejecting heat inlet, a first hot water inlet, and a first hot water outlet; the first high-pressure ejecting inlet is connected to the high-temperature preheating steam outlet; the first low-pressure ejecting inlet is connected to the first drying outlet; the first ejecting outlet is connected to the first ejecting heat inlet; the outlet of the hot water tank is connected to the first hot water inlet.

Further, the sludge drying device comprises a second ejector, a second vacuum dryer, and a second heating water jacket; the second ejector comprises a second high-pressure ejecting inlet, a second low-pressure ejecting inlet, and a second ejecting outlet; the wet sludge inlet and the dried sludge outlet are provided on the second vacuum dryer, which further comprises a second drying outlet; the second heating water jacket comprises a second ejecting heat inlet, a second hot water inlet, and a second hot water outlet; the second high-pressure ejecting inlet is connected to the high-temperature preheating steam outlet; the second low-pressure ejecting inlet is connected to the second drying outlet; the second ejecting outlet is connected to the second ejecting heat inlet; the outlet of the hot water tank is connected to the second hot water inlet; the first hot water outlet and the second hot water outlet are further connected to a sewage pool.

Compared with the prior art, the present invention provides the following beneficial effects:

First, the low carbon emission coupled treatment system and method for waste of the present invention utilize biogas produced by fermenting organic residue separated from kitchen waste. The biogas is burned to heat methanol liquid. The methanol steam generated from the heated methanol liquid is mixed with high-temperature and high-pressure steam produced by the heat recovery boiler, and the mixture is subjected to catalytic hydrogen production, thereby achieving reutilization of waste resources. Other combustible gases generated during the catalytic hydrogen production are separated from hydrogen and fed back into the waste incinerator for combustion and heat release. Meanwhile, a mixture of biomass waste and dried sludge is used as fuel for coupled gasification to produce biomass gas, which promotes the combustion of dried kitchen waste, sludge, and domestic waste in the waste incinerator. This improves the waste combustion treatment efficiency and eliminates the need for additional high-calorific-value auxiliary fuels.

Second, the method utilizes a mixture of high-volatile-content agricultural and forestry waste and dried sludge as fuel, and employs a gasifying agent composed of high-temperature flue gas, steam, and high-temperature air generated by the waste incinerator. Through high-temperature redox reactions, the method produces high-calorific-value biomass gas with high gasification efficiency. The biomass gas promotes waste combustion in the waste incinerator, ensuring stable combustion of waste without adding other high-calorific-value auxiliary fuels. It also increases the blending ratio of sludge and kitchen waste, reduces slagging in the furnace and the emission of harmful gas, and saves labor and material costs.

### BRIEF DESCRIPTION OF DRAWINGS

FIG. 1 is a schematic diagram showing the overall structure of the low carbon emission coupled treatment system for waste of the present invention.

FIG. 2 is an enlarged view of the kitchen waste drying device and the sludge drying device shown in FIG 1.

In the drawings: 1—kitchen waste sorting device; 11—large wet waste outlet; 12—organic residue outlet; 2—biogas fermentation tank; 21—organic residue inlet; 22—biogas outlet; 3—methanol heating device; 31—combustion chamber; 32—heating chamber; 321—methanol liquid inlet; 322—methanol steam outlet; 4—mixer; 41—steam inlet; 42—methanol steam inlet; 43—mixed raw material outlet; 5—catalytic hydrogen production device; 51—raw material inlet; 52—mixed gas outlet; 6—adsorption-desorption bed; 61—reaction product inlet; 62—hydrogen outlet; 63—mixed combustible gas outlet; 7—kitchen waste drying device; 71—first ejector; 711—first high-pressure ejecting inlet; 712—first low-pressure ejecting inlet; 713—first ejecting outlet; 72—first vacuum dryer; 721—large wet waste inlet; 722—dried kitchen waste outlet; 723—first drying outlet; 73—first heating water jacket; 731—first ejecting heat inlet; 732—first hot water inlet; 733—first hot water outlet; 74—hot water tank; 8—sludge drying device; 81—second ejector; 811—second high-pressure ejecting inlet; 812—second low-pressure ejecting inlet; 813—second ejecting outlet; 82—second vacuum dryer; 821—wet sludge inlet; 822—dried sludge outlet; 823—second drying outlet; 83—second heating water jacket; 831—second ejecting heat inlet; 832—second hot water inlet; 833—second hot water outlet; 9—waste incinerator; 91—mixed combustible gas inlet; 92—dried kitchen waste inlet; 93—biomass gas inlet; 94—dried sludge combustion inlet; 95—combustion hot air inlet; 96—first flue gas outlet; 97—domestic waste inlet; 98—second flue gas outlet; 10—heat recovery boiler; 101—boiler body; 102—low-temperature steam outlet; 103—high-temperature steam outlet; 104—user steam outlet; 20—biomass gasifier; 201—biomass waste inlet; 202—biomass gas outlet; 203—sludge gasification inlet; 204—gasification hot air inlet; 205—gasification steam inlet; 206—gasification flue gas inlet; 30—low-temperature air preheater; 301—external air inlet; 302—low-temperature preheated air outlet; 303—low-temperature preheating steam inlet; 304—low-temperature preheating steam outlet; 40—high-temperature air preheater; 401—high-temperature preheated air inlet; 402—high-temperature preheated air outlet; 403—high-temperature preheating steam inlet; 404—high-temperature preheating steam outlet; 50—deaerator; 60—chimney; 70—sewage pool.

### DETAILED DESCRIPTION

The drawings are provided solely for exemplary illustration and shall not be construed as limiting the scope of the present patent. For the purpose of better illustrating the examples, certain components in the drawings may be omitted, enlarged, or reduced in size, which does not represent the actual dimensions of the product. It is understood by those skilled in the art that certain well-known structures and their descriptions may be omitted from the drawings. The positional relationships described in the drawings are provided for illustrative purposes only and shall not be interpreted as limiting the present patent.

In the drawings of the examples of the present invention, identical or similar reference numerals refer to identical or similar components. In the description of the present invention, it should be understood that terms such as “upper,” “lower,” “left,” “right,” “long,” and “short,” which indicate orientations or positional relationships, are based solely on the orientations or positional relationships shown in the drawings. These terms are provided merely for the purpose of describing the invention and simplifying the explanation, and are not intended to indicate or imply that the referenced devices or elements must have a specific orientation or must be constructed or operated in a specific orientation. Therefore, the expressions describing positional relationships in the drawings are for illustrative purposes only and shall not be construed as limiting the present patent. Those skilled in the art can understand the specific meanings of such terms based on the actual context.

The technical solution of the present invention will be further described in detail below through specific example and with reference to the accompanying drawings:

### Example 1

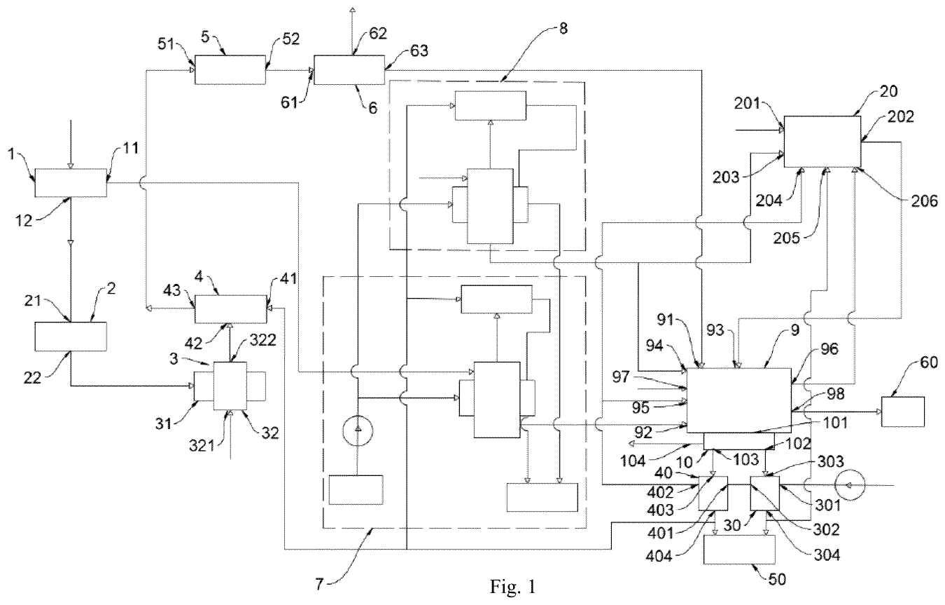

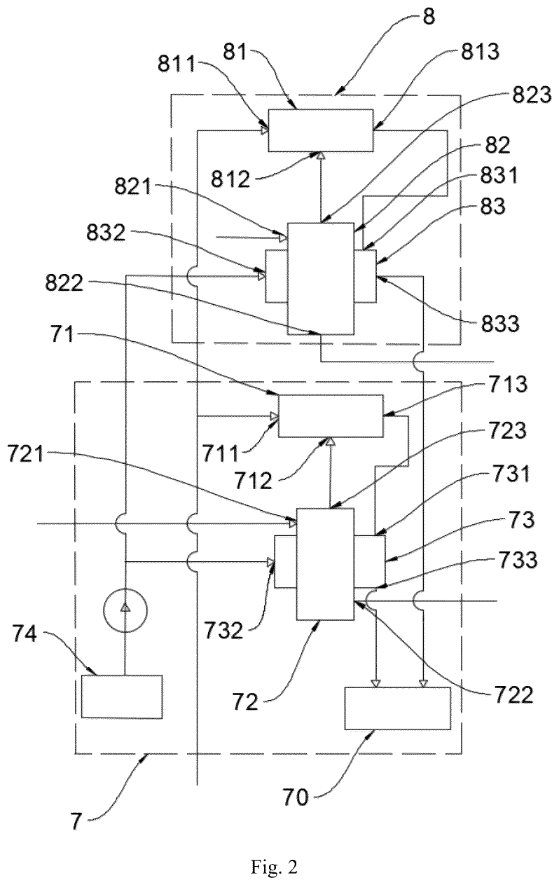

In conjunction with the systems shown in FIG. 1 and FIG. 2, this example discloses a low carbon emission coupled treatment method for waste, comprising the following steps:

S1: the kitchen waste is sorted to separate large wet waste and organic residue, the large wet waste is dried and then fed into the waste incinerator 9 for combustion;

S2: the organic residue is fermented to produce biogas, the biogas is burned to heat methanol liquid and generate methanol steam, the heat recovery boiler 10 connected to the waste incinerator 9 is utilized to produce high-temperature and high-pressure steam, the methanol steam is mixed with a portion of the high-temperature and high-pressure steam, and the mixture is conducted through catalytic hydrogen production to obtain a mixed gases rich in hydrogen;

S3: the sludge is dried, a portion of the dried sludge is fed into the biomass gasifier 20 to perform coupled gasification fueled with the mixture of dried sludge and biomass waste and generate biomass gas, the remaining dried sludge is fed into the waste incinerator 9 for co-combustion with waste;

S4: the mixed gases rich in hydrogen obtained from catalytic hydrogen production are separated to yield hydrogen and other combustible gases, the hydrogen is delivered externally, the biomass gas and the other combustible gases are fed into the waste incinerator 9 for co-combustion with waste.

In this example, the organic residue separated from the kitchen waste is fermented to produce biogas, the biogas is burned to heat methanol liquid to turn it into steam, the methanol steam is mixed with high-temperature and high-pressure steam generated by the heat recovery boiler 10, and the mixture is conducted through catalytic hydrogen production to obtain a mixed gases rich in hydrogen, thereby achieving reutilization of waste resources. Subsequently, other combustible gases generated during the catalytic hydrogen production are separated from the hydrogen, then the combustible gases are fed back into the waste incinerator 9 for combustion and heat is released. Meanwhile, a mixture of biomass waste and dried sludge is used as raw material to perform coupled gasification and generate biomass gas. The biomass gas promotes the co-combustion of dried kitchen waste and sludge, thereby improving the efficiency of waste combustion treatment without adding additional high-calorific-value auxiliary fuel. In some examples, domestic waste is fed into the waste incinerator 9 to achieve co-combustion of dried kitchen waste, sludge, and domestic waste.

Specifically, the kitchen waste may be sorted in the following manner: dedicated kitchen waste collection and transportation vehicles are uniformly weighed on a truck scale before entering the site; the vehicles unload the kitchen waste at a designated location in the unloading hall of the main plant building, discharging the kitchen waste into a receiving hopper. The kitchen waste is subjected to processes including sorting, impurity removal, sand removal, and pressing, so as to extract large inorganic impurities (such as metal, sand, bones, and plastic bags) from the kitchen waste to form large wet waste, and to obtain a remaining homogeneous granular slurry containing partial organic matter. The slurry is subjected to a second time, and grease is extracted from the slurry through an oil-water-solid three-phase separation system, thereby obtaining grease and organic residue. The grease may be used for other purposes; the remaining organic residue after grease extraction may be used for fermentation to produce biogas. The sorting process of the kitchen waste may be performed using an existing kitchen waste sorting device 1.

In the method of this example, porous Ni/Al₂O₃ is used as the catalyst for catalytic hydrogen production. Hydrogen and other combustible gases are separated from the mixed gases rich in hydrogen obtained by catalytic hydrogen production, by utilizing an adsorption-desorption bed.

Specifically, the adsorption-desorption bed is an existing device that separates hydrogen based on the principle of pressure swing adsorption. The pressure swing adsorption process utilizes solid adsorbents such as silicon carbide gel, activated carbon, and molecular sieves, which are filled inside a vertical pressure vessel, to selectively adsorb impurities such as CO2 from the mixed gases rich in hydrogen. Because the components in the mixed gases rich in hydrogen have different boiling points, when the feed gas passes through the adsorbent bed, the adsorbents selectively adsorb components other than hydrogen as impurities. Hydrogen, which has the lowest boiling point and the highest volatility, is scarcely adsorbed, and exits the adsorption bed with a purity of approximately greater than 98v %, thereby achieving separation from other impurities. According to the feed ratio, the reaction equation for hydrogen production is: 9CH₃OH (g)+8H₂O (g) →26H₂ (g)+7.5CO₂ (g)+1.5CO (g). During the reaction process, a small amount of CH₄ is also produced.

In this example, 10% to 20% of the total amount of dried sludge is fed into the biomass gasifier 20, and the remaining sludge is fed into the waste incinerator 9. Optionally, 15% of the dried sludge is fed into the biomass gasifier 20 to perform coupled gasification with biomass waste, and 85% of the dried sludge is fed into the waste incinerator 9 to achieve co-combustion with the dried kitchen waste and domestic waste.

In this example, both the large wet waste and the sludge are dried by adopting the method of vacuum drying. The large wet waste and sludge are heated and dried in a vacuum environment, which enables drying at a lower temperature; by lowering the drying temperature, the thermal energy of low-temperature hot water is utilized for drying instead of steam, thereby significantly reducing the drying cost.

### Example 2

In conjunction with the systems shown in FIG. 1 and FIG. 2, this example discloses a low carbon emission coupled treatment method for waste. This example is similar to Example 1, the difference lies in that the method in this example further comprises the following step: preheated air is obtained through an air preheater connected to the waste incinerator 9; a portion of the preheated air is fed into the waste incinerator 9 to assist combustion; and another portion of the preheated air high-temperature hot air, the high-temperature and high-pressure steam, and a portion of the hot flue gas generated by the waste incinerator 9 is fed into the biomass gasifier 20 as a gasifying agent to perform coupled gasification.

The high-temperature steam generated by the heat recovery boiler 10 is primarily supplied for user applications, and a portion of the steam is used in the air preheater to preheat external air, thereby obtaining hot air to promote waste combustion in the waste incinerator 9. In some examples, the air preheater may comprise a high-temperature air preheater 40 and a low-temperature air preheater 30. External air is first preheated through the low-temperature air preheater 30, and then preheated through the high-temperature air preheater 40 for secondary preheating. The waste steam obtained through the low-temperature air preheater 30 has relatively lower temperature and pressure, making it more suitable for use in the biomass gasifier 20. The waste steam obtained through the high-temperature air preheater 40 has a higher temperature and is more suitable for mixing with methanol steam for catalytic hydrogen production.

In this example, a mixture of high-volatile-content agricultural and forestry waste and dried sludge is used as feedstock, and a gasifying agent composed of high-temperature flue gas, steam, and high-temperature air generated by the waste incinerator 9 is employed. The feedstock and gasifying agent are subjected to a high-temperature redox reaction to produce biomass gas with high gasification efficiency. The biomass gas is used to promote waste combustion in the waste incinerator 9. Without adding other high-calorific-value auxiliary fuels, stable waste combustion in the waste incinerator 9 is ensured, the co-combustion ratio of sludge and kitchen waste is increased, furnace slagging and the emission of harmful gases are reduced, and labor and material costs are saved.

In some examples, the flue gas generated by the waste incinerator 9 has a temperature of approximately 180° C. The external air, after passing through the high-temperature air preheater, is heated to approximately 220° C. The steam generated by the heat recovery boiler 10 at a pressure of approximately 30 kilograms passes through the high-temperature air preheater 40 and is converted into steam with a pressure of approximately 20 kilograms and a temperature of approximately 200° C. The steam generated by the heat recovery boiler 10 at a pressure of approximately 13 kilograms passes through the low-temperature air preheater 30 and is converted into steam with a pressure of approximately 8 kilograms. Methanol liquid is heated to obtain methanol steam at approximately 700° C. The methanol steam is mixed with steam at a pressure of approximately 20 kilograms and a temperature of approximately 200° C. in a mixer 4, and the mixture is conducted through catalytic hydrogen production at a temperature of approximately 400° C. to 500° C.

### Example 3

Referring to FIG. 1 and FIG. 2, this example discloses a low carbon emission coupled treatment system for waste, comprising a kitchen waste sorting device 1, a biogas fermentation tank 2, a methanol heating device 3, a mixer 4, a catalytic hydrogen production device 5, an adsorption-desorption bed 6, a kitchen waste drying device 7, a sludge drying device 8, a waste incinerator 9, a heat recovery boiler 10, and a biomass gasifier 20. The kitchen waste sorting device 1 comprises a large wet waste outlet 11 and an organic residue outlet 12. The biogas fermentation tank 2 comprises an organic residue inlet 21 and a biogas outlet 22. The methanol heating device 3 comprises a combustion chamber 31 and a heating chamber 32, wherein the heating chamber 32 comprises a methanol liquid inlet 321 and a methanol steam outlet 322. The mixer 4 comprises a steam inlet 41, a methanol steam inlet 42, and a mixed raw material outlet 43. The catalytic hydrogen production device 5 comprises a raw material inlet 51 and a mixed gas outlet 52. The adsorption-desorption bed 6 comprises a reaction product inlet 61, a hydrogen outlet 62, and a mixed combustible gas outlet 63. The kitchen waste drying device 7 comprises a large wet waste inlet 721 and a dried kitchen waste outlet 722. The sludge drying device 8 comprises a wet sludge inlet 821 and a dried sludge outlet 822. The waste incinerator 9 comprises a mixed combustible gas inlet 91, a dried kitchen waste inlet 92, a biomass gas inlet 93, a dried sludge combustion inlet 94, and a domestic waste inlet 97. The heat recovery boiler 10 comprises a boiler body 101, a low-temperature steam outlet 102, and a high-temperature steam outlet 103. The biomass gasifier 20 comprises a biomass waste inlet 201, a biomass gas outlet 202, and a sludge gasification inlet 203. The large wet waste outlet 11 is connected to the large wet waste inlet 721. The organic residue outlet 12 is connected to the organic residue inlet 21. The biogas outlet 22 is connected to the combustion chamber 31. The dried kitchen waste outlet 722 is connected to the dried kitchen waste inlet 92. The boiler body 101 is connected to the waste incinerator 9. The high-temperature steam outlet 103 is connected to the steam inlet 41. The methanol steam outlet 322 is connected to the methanol steam inlet 42. The mixed raw material outlet 43 is connected to the raw material inlet 51. The mixed gas outlet 52 is connected to the reaction product inlet 61. The mixed combustible gas outlet 63 is connected to the mixed combustible gas inlet 91. The biomass gas outlet 202 is connected to the biomass gas inlet 93. The dried sludge outlet 822 is connected to both the sludge gasification inlet 203 and the dried sludge combustion inlet 94. Through the domestic waste inlet 97, the system allows feeding of domestic waste, so that the dried kitchen waste, dried sludge, and domestic waste are co-combusted in the waste incinerator 9.

The heat recovery boiler 10 comprises a user steam outlet 104, and the user steam outlet 104 is connected to external user equipment for utilization. The high-temperature steam generated by the heat recovery boiler 10 is delivered to users through the steam outlet 104, and a portion of the steam is used to preheat external air in the air preheater.

In this example, the low carbon emission coupled treatment system for waste further comprises a low-temperature air preheater 30 and a high-temperature air preheater 40. The low-temperature air preheater 30 comprises an external air inlet 301, a low-temperature preheated air outlet 302, a low-temperature preheating steam inlet 303, and a low-temperature preheating steam outlet 304. The high-temperature air preheater 40 comprises a high-temperature preheated air inlet 401, a high-temperature preheated air outlet 402, a high-temperature preheating steam inlet 403, and a high-temperature preheating steam outlet 404. The waste incinerator 9 comprises a combustion hot air inlet 95, a first flue gas outlet 96, and a second flue gas outlet 98. The biomass gasifier 20 comprises a gasification hot air inlet 204, a gasification steam inlet 205, and a gasification flue gas inlet 206. The low-temperature steam outlet 102 is connected to the low-temperature preheating steam inlet 303. The high-temperature steam outlet 103 is connected to the high-temperature preheating steam inlet 403. The high-temperature preheated air outlet 402 is connected to both the combustion hot air inlet 95 and the gasification hot air inlet 204. The gasification steam inlet 205 is connected to the low-temperature preheating steam outlet 304. The steam inlet 41 is connected to the high-temperature preheating steam outlet 404. The gasification flue gas inlet 206 is connected to the first flue gas outlet 96. The second flue gas outlet 98 is connected to a chimney 60. A small portion of the flue gas generated by the waste incinerator 9 enters the biomass gasifier 20 through the first flue gas outlet 96, while the majority of the flue gas is discharged through the chimney 60 via the second flue gas outlet 98.

In some examples, the low-temperature preheating steam outlet 304 and the high-temperature preheating steam outlet 404 are each connected to a deaerator 50 to remove oxygen from the boiler feedwater and prevent equipment corrosion.

In this example, the waste incinerator is connected to a chimney 60 to discharge the majority of excess flue gas generated in the waste incinerator.

In this example, the kitchen waste drying device 7 comprises a first ejector 71, a first vacuum dryer 72, a first heating water jacket 73, and a hot water tank 74. The first ejector 71 comprises a first high-pressure ejecting inlet 711, a first low-pressure ejecting inlet 712, and a first ejecting outlet 713. The large wet waste inlet 721 and the dried kitchen waste outlet 722 are provided on the first vacuum dryer 72, which further comprises a first drying outlet 723. The first heating water jacket 73 comprises a first ejecting heat inlet 731, a first hot water inlet 732, and a first hot water outlet 733. The first high-pressure ejecting inlet 711 is connected to the high-temperature preheating steam outlet 404. The first low-pressure ejecting inlet 712 is connected to the first drying outlet 723. The first ejecting outlet 713 is connected to the first ejecting heat inlet 731. The outlet of the hot water tank 74 is connected to the first hot water inlet 732.

In this example, the sludge drying device 8 comprises a second ejector 81, a second vacuum dryer 82, and a second heating water jacket 83. The second ejector 81 comprises a second high-pressure ejecting inlet 811, a second low-pressure ejecting inlet 812, and a second ejecting outlet 813. The wet sludge inlet 821 and the dried sludge outlet 822 are provided on the second vacuum dryer 82, which further comprises a second drying outlet 823. The second heating water jacket 83 comprises a second ejecting heat inlet 831, a second hot water inlet 832, and a second hot water outlet 833. The second high-pressure ejecting inlet 811 is connected to the high-temperature preheating steam outlet 404. The second low-pressure ejecting inlet 812 is connected to the second drying outlet 823. The second ejecting outlet 813 is connected to the second ejecting heat inlet 831. The outlet of the hot water tank 74 is connected to the second hot water inlet 832.

In some examples, the first hot water outlet 733 and the second hot water outlet 833 are further connected to a sewage pool 70. The sewage pool 70 is used to collect contaminated wastewater generated by the first heating water jacket 73 and the second heating water jacket 83.

The system of this example is used in conjunction with the method of Example 1 or Example 2, and is capable of coupling the treatment of kitchen waste, domestic sludge, and biomass waste, while utilizing waste resources to produce hydrogen.

It is clear that the above examples of the present invention are provided solely for the purpose of clearly illustrating the invention, and are not intended to limit the implementation of the present invention. Based on the above description, the person skilled in the art may make other variations or modifications in different forms. It is neither necessary nor possible to exhaustively enumerate all possible examples herein. Any modifications, equivalent replacements, or improvements made within the spirit and principles of the present invention shall fall within the scope of protection defined by the claims of the present invention.

1. A low carbon emission coupled treatment method for waste, comprising the steps of:
kitchen waste is sorted to separate large wet waste and organic residue, the large wet waste is dried and then fed into a waste incinerator for combustion, heat of flue gas generated by the waste incinerator is utilized to heat a heat recovery boiler to produce high-temperature and high-pressure steam;
the organic residue is fermented to produce biogas, the biogas is burned to heat methanol liquid to generate methanol steam, the methanol steam is mixed with the high-temperature and high-pressure steam, and the mixture is conducted through catalytic hydrogen production to obtain a mixed gases rich in hydrogen;
sludge is dried, a portion of the dried sludge is fed into a biomass gasifier, to perform coupled gasification fueled with the mixture of dried sludge and biomass waste and generate biomass gas, the remaining dried sludge is fed into the waste incinerator for co-combustion with waste;
the mixed gases rich in hydrogen obtained from catalytic hydrogen production are separated to yield hydrogen and other combustible gases, the hydrogen is delivered externally, the biomass gas and the other combustible gases are fed into the waste incinerator for co-combustion with waste.

2. The low carbon emission coupled treatment method for waste according to claim 1, wherein the catalytic hydrogen production utilizes porous Ni/Al₂O₃ as a catalyst.

3. The low carbon emission coupled treatment method for waste according to claim 1, wherein the mixed gases rich in hydrogen obtained from the catalytic hydrogen production are subjected to separation of hydrogen and other combustible gases utilizing an adsorption-desorption bed.

4. The low carbon emission coupled treatment method for waste according to claim 1, wherein the method further comprises the steps of: preheated air is obtained through an air preheater connected to the waste incinerator, a portion of the preheated air is fed into the waste incinerator to assist combustion, and another portion of the preheated air, the high-temperature and high-pressure steam, and a portion of the flue gas generated by the waste incinerator is fed into the biomass gasifier to perform coupled gasification.

5. The low carbon emission coupled treatment method for waste according to claim 1, wherein 10% to 20% of the dried sludge is fed into the biomass gasifier, and the remaining sludge is fed into the waste incinerator.

6. The low carbon emission coupled treatment method for waste according to claim 1, wherein both the large wet waste and the sludge are dried by adopting the method of vacuum drying.

7. A low carbon emission coupled treatment system for waste, comprising: a kitchen waste sorting device, a biogas fermentation tank, a methanol heating device, a mixer, a catalytic hydrogen production device, an adsorption-desorption bed, a kitchen waste drying device, a sludge drying device, a waste incinerator, a heat recovery boiler, and a biomass gasifier;
the kitchen waste sorting device comprises a large wet waste outlet and an organic residue outlet;
the biogas fermentation tank comprises an organic residue inlet and a biogas outlet;
the methanol heating device comprises a combustion chamber and a heating chamber, the heating chamber comprising a methanol liquid inlet and a methanol steam outlet;
the mixer comprises a steam inlet, a methanol steam inlet, and a mixed raw material outlet;
the catalytic hydrogen production device comprises a raw material inlet and a mixed gas outlet;
the adsorption-desorption bed comprises a reaction product inlet, a hydrogen outlet, and a mixed combustible gas outlet;
the kitchen waste drying device comprises a large wet waste inlet and a dried kitchen waste outlet;
the sludge drying device comprises a wet sludge inlet and a dried sludge outlet;
the waste incinerator comprises a mixed combustible gas inlet, a dried kitchen waste inlet, a biomass gas inlet, a dried sludge combustion inlet, and a domestic waste inlet;
the heat recovery boiler comprises a boiler body, a low-temperature steam outlet, and a high-temperature steam outlet;
the biomass gasifier comprises a biomass waste inlet, a biomass gas outlet, and a sludge gasification inlet;
the large wet waste outlet is connected to the large wet waste inlet ;
the organic residue outlet is connected to the organic residue inlet;
the biogas outlet is connected to the combustion chamber;
the dried kitchen waste outlet is connected to the dried kitchen waste inlet;
the boiler body is connected to the waste incinerator;
the high-temperature steam outlet is connected to the steam inlet through a high-temperature air preheater;
the methanol steam outlet is connected to the methanol steam inlet;
the mixed raw material outlet is connected to the raw material inlet;
the mixed gas outlet is connected to the reaction product inlet;
the mixed combustible gas outlet is connected to the mixed combustible gas inlet;
the biomass gas outlet is connected to the biomass gas inlet;
the dried sludge outlet is connected to both the sludge gasification inlet and the dried sludge combustion inlet.

8. The low carbon emission coupled treatment system for waste according to claim 7, wherein the system further comprises a low-temperature air preheater and a high-temperature air preheater;
the low-temperature air preheater comprises an external air inlet, a low-temperature preheated air outlet, a low-temperature preheating steam inlet, and a low-temperature preheating steam outlet;
the high-temperature air preheater comprises a high-temperature preheated air inlet, a high-temperature preheated air outlet, a high-temperature preheating steam inlet, and a high-temperature preheating steam outlet;
the waste incinerator comprises a combustion hot air inlet, a first flue gas outlet, and a second flue gas outlet;
the biomass gasifier comprises a gasification hot air inlet, a gasification steam inlet, and a gasification flue gas inlet;
the low-temperature steam outlet is connected to the low-temperature preheating steam inlet;
the high-temperature steam outlet is connected to the high-temperature preheating steam inlet;
the high-temperature preheated air outlet is connected to both the combustion hot air inlet and the gasification hot air inlet;
the gasification steam inlet is connected to the low-temperature preheating steam outlet;
the steam inlet is connected to the high-temperature preheating steam outlet;
the gasification flue gas inlet is connected to the first flue gas outlet;
the second flue gas outlet is connected to a chimney.

9. The low carbon emission coupled treatment system for waste according to claim 8, wherein the kitchen waste drying device comprises a first ejector, a first vacuum dryer, a first heating water jacket, and a hot water tank;
the first ejector comprises a first high-pressure ejecting inlet, a first low-pressure ejecting inlet, and a first ejecting outlet;
the large wet waste inlet and the dried kitchen waste outlet are provided on the first vacuum dryer, which further comprises a first drying outlet;
the first heating water jacket comprises a first ejecting heat inlet, a first hot water inlet, and a first hot water outlet;
the first high-pressure ejecting inlet is connected to the high-temperature preheating steam outlet;
the first low-pressure ejecting inlet is connected to the first drying outlet;
the first ejecting outlet is connected to the first ejecting heat inlet;
the outlet of the hot water tank is connected to the first hot water inlet.

10. The low carbon emission coupled treatment system for waste according to claim 9, wherein the sludge drying device comprises a second ejector, a second vacuum dryer, and a second heating water jacket;
the second ejector comprises a second high-pressure ejecting inlet, a second low-pressure ejecting inlet, and a second ejecting outlet;
the wet sludge inlet and the dried sludge outlet are provided on the second vacuum dryer, which further comprises a second drying outlet;
the second heating water jacket comprises a second ejecting heat inlet, a second hot water inlet, and a second hot water outlet;
the second high-pressure ejecting inlet is connected to the high-temperature preheating steam outlet;
the second low-pressure ejecting inlet is connected to the second drying outlet;
the second ejecting outlet is connected to the second ejecting heat inlet;
the outlet of the hot water tank is connected to the second hot water inlet;
the first hot water outlet and the second hot water outlet are further connected to a sewage pool.
